(19) United States
(12) Patent Application Publication
(10) Pub. No.: US 2007/0112890 A1
(43) Pub. Date: May 17, 2007

(54) Computerized system and method for document management

(75) Inventor: Atsushi Murase, Sunnyvale, CA (US)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD., Tokyo (JP)

(21) Appl. No.: 11/272,339

(22) Filed: Nov. 12, 2005

(51) Int. Cl. G06F 17/30

(52) U.S. Cl. 707/204

(57) ABSTRACT

Document management system and method for storing documents having a first storage device storing user-viewable portal data and a second storage device storing document body data and a metadata table storing information and correspondence relationships between the portal and body data for each document. The first and second storage devices have different characteristics. For example, the first storage device may have a higher data access speed than the second storage device. The document management system further includes a storage device manager which allocates storage areas for the data in various storage devices and a document manager, which causes the portal data to be stored in the first storage device and the body data to be stored in the second storage device. The document manager also adds a respective record of the stored portal data and the stored body data into a metadata table of a corresponding document container.

### BACKGROUND OF THE INVENTION

1. Field of the Invention

The present invention generally relates to storing and managing computer data, and more specifically to a storage system and method for efficient data browsing and retrieval.

2. Description of the Related Art

In browsing through large collections of data, short data summaries or abstracts may be first shown to a user in order to enable the user to more quickly navigate through large volumes of information. To this end, various documents may include document abstracts or summaries (hereinafter “portal data”), in addition to the data comprising the main body of the document (hereinafter “body data”). Certain industry standards as well as government regulations may also require the aforementioned double-tier document structure.

For example, medical information may include clinical records (portal data) and X-ray images or inspection results (body data). Similarly, photo data may include thumb nails (portal data) in addition to the actual images (body data). E-mailed documents may have the text of the e-mail (portal data) and the attached documents (body data).

It should be noted that while the portal data needs to be stored on fast storage media to enable efficient browsing by the user, it would be prohibitively expensive to use the fast storage media to store substantially more voluminous body data.

Unfortunately, the existing storage systems are not designed to take the most advantage of aforementioned double-tier document structure and store all the components of the document on the same storage media, which can be either too slow or too expensive.

### SUMMARY OF THE INVENTION

One of the aspects of the present invention is to provide a quicker browsing, portal data. Another aspect of the present invention is to efficiently use of the storage devices with various characteristics.

Illustrative, non-limiting embodiments of the present invention may overcome the above disadvantages and other disadvantages not described above. The present invention is not necessarily required to overcome any of the disadvantages described above, and the illustrative, non-limiting embodiments of the present invention may not overcome any of the problems described above. The appended claims should be consulted to ascertain the true scope of the invention.

Accordingly to an exemplary, non-limiting formulation of the present invention, a data management system is provided. The data management system includes a-first storage device storing first user-viewable data and at least one second storage device, physically separate from the first storage device, storing at least one second data. The at least one second data is associated with the first data. The data management system includes a metadata storage area storing metadata associated with the first data and the at least one second data and a storage device management processor operable to cause allocation of storage areas of the first and the at least one second storage devices. The data management system includes a data management processor operable to cause the first data to be stored in the first storage device and the at least one second data to be stored in the at least one second storage device and to cause a record to be added into the metadata storage area, the record indicating a relationship between the stored first data and the at least one stored second data. The storage device management processor is operable to cause allocation of a storage area for the first data and a storage area for the at least one second data based on a request from the data management processor.

According to an exemplary, non-limiting formulation of the present invention, a data management method is provided. The data management method includes receiving first user-viewable data and second data, automatically separating the first data and the second data, and allocating a storage area of a first storage device and a storage area of at least one second storage device. The method further includes storing the first data in the allocated storage area of the first data storage device, storing the second data in the allocated storage area of the at least one second storage device, physically separate from the first storage device. The at least one second data is associated with the first data. The method also includes adding a record into the metadata storage area. The record indicates a relationship between the stored first data and the at least one stored second data and the metadata is associated with the first data and the at least one second data.

According to an exemplary, non-limiting formulation of the present invention, a computer-readable medium embodying one or more sequences of instructions, which when executed by one or more processors, causes the one or more processors to perform a method, which includes receiving first user-viewable data and second data, automatically separating the first data and the second data, and allocating a storage area of a first data storage device and allocating a storage area of at least one second storage device. The method further includes storing the first data in the allocated storage area of the first data storage device and storing the second data in the allocated storage area of the at least one second storage device, physically separate from the first storage device. The at least one second data is associated with the first data. The method further includes adding a record into the metadata storage area. The record indicates a relationship between the stored first data and the at least one-stored second data. The metadata is associated with the first data and the at least one second data.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 is a block diagram illustrating hardware architecture of the storage system according to an exemplary embodiment of the present invention.

FIG. 2 is a block diagram illustrating the software of the storage system according to an exemplary embodiment of the present invention.

FIG. 3 is a structural diagram of a document container according to an exemplary embodiment of the present invention.

FIG. 4 illustrates data structure of the metadata table according to an exemplary embodiment of the present invention

FIG. 5 illustrates a data structure of the storage area attribute table according to an exemplary embodiment of the present invention.

FIG. 6 illustrates data structure of a storage area parameter sheet according to an exemplary embodiment of the present invention.

FIG. 7 illustrates data structure of the allocation storage area table according to an exemplary embodiment of the present invention.

FIG. 8 illustrates data structure of an application table according to an exemplary embodiment of the present invention.

FIG. 9 is a view illustrating a user interface for managing document containers according to an exemplary embodiment of the present invention.

FIGS. 10A and B are, respectively, a view illustrating a user interface for managing data within a container according to an exemplary embodiment of the present invention and a flow chart illustrating the process of launching application to view selected data according to an exemplary embodiment of the present invention.

FIGS. 11A, 11B, and 11C are, respectively, a view illustrating a user interface for adding and/or storing documents in a container according to an exemplary embodiment of the present invention, a flow chart illustrating the process of adding and/or storing documents in a container according to an exemplary embodiment of the present invention, and a flow chart illustrating the process of adding and/or storing a new folder in a container according to an exemplary embodiment of the present invention.

FIG. 12 illustrates a user interface for creating a new document container according to an exemplary embodiment of the present invention.

FIG. 13 is a flow chart illustrating a process of creating a new document container according to an exemplary embodiment of the present invention.

FIG. 14 is a flow chart illustrating a process of allocating storage area for data of a new document container according to an exemplary embodiment of the present invention.

FIG. 15 illustrates a user interface for registering a new application according to an exemplary embodiment of the present invention.

FIG. 16 illustrates logical structure of the migration process according to an exemplary embodiment of the present invention.

FIG. 17 illustrates logical structure of the storage area attribute table according to an exemplary embodiment of the present invention.

FIG. 18 is a flow chart illustrating process for creating a new document container according to an exemplary embodiment of the present invention.

FIG. 19 illustrates logical structure of the migration process according to an exemplary embodiment of the present invention.

FIG. 20 is a flow chart illustrating process of migrating a document container to a new storage device according to an exemplary embodiment of the present invention.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not-to be construed in a limited sense. Additionally, the various embodiments of the invention as described may be implemented in the form of a software running on a general purpose computer, in the form of a specialized hardware, or combination of software and hardware.

Modern data storage systems provide the user with a wide range of available storage media performance options. Most of today's storage devices can allocate storage areas with user-specified characteristics. According to SMI-S (Storage Management Initiative Specification), administered by SNIA (Storage Networking Industry Association), which is becoming widely adopted by storage vendors, storage areas with desired performance characteristics may be allocated using user-specified “hints”, which abstractly represent the storage requirements.

When a user browses through numerous documents on a specific topic, the user may want to have abstracts load quickly, so that the user can quickly get to the relevant document. On the other hand, once the specific document has been located, the user may be willing to wait a bit longer for the content of the actual document to load. Therefore, it may be advantageous to store the portal data (for example abstract) and body data of documents on separate storage devices having different performance characteristics in order to take full advantage of the double-tier document structure, wherein documents are composed of the portal data and body data. Specifically, an embodiment of the inventive system utilizes expensive fast storage media to store portal data in order to enable fast user browsing, while storing the bulky body data on a cheaper, slower media.

In the exemplary embodiment of the above inventive concept, the portal data and body data of a document are apportioned to two or more separate storage devices, with the relationship between the portal data and the corresponding body data being automatically maintained by the inventive system. By way of an-example, portal data associated with body data is stored on a high speed storage device (hereinafter “tier one” device), and corresponding body data is stored on a cheaper, large and slower device (hereinafter “tier two” device). It should be noted that there may be multiple body data segments corresponding to the same portal data. Such multiple body data segments may or may not be stored on the same storage device.

The relationships between the portal data and the body data is maintained by the inventive system so that the user can easily load body data related to the portal data being viewed. The relationship of the portal data to body data can be described as N to M relationship. That is, in an embodiment of the inventive system, there may be M body data objects corresponding to N portal data objects. Accordingly, the portal data and the body data may belong to a number of groups or containers, described in further detail below.

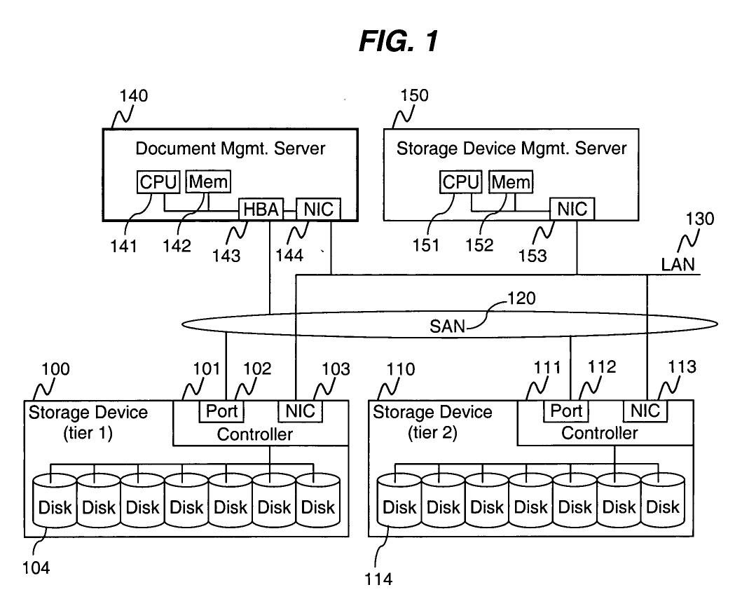

FIG. 1 is an exemplary block diagram of the physical hardware architecture of the storage system according to an exemplary embodiment of the inventive concept the exemplary storage system depicted in FIG. 1 contains two storage devices 100 and 110, two servers 140 and 150, and networks 120 and 130 connecting these four devices to each other. In the shown exemplary embodiment, the network 120 is a fiber channel network SAN and the network 130 is a local access network (LAN).

In the example depicted in FIG. 1, the storage device 100 contains a number of high speed hard disk drives 104, such as drives with fiber channel interface. On the other hand, the storage device 110 contains a number of low cost hard disk drives, such as drives utilizing advanced technology attachment (ATA) interface. Accordingly, the storage device 100 may be classified as a tier one storage device providing high speeds of data access at a high cost per megabyte. On the other hand, the storage device 110 provides low cost data storage, but is characterized by slower data access speed, and, therefore, is classified as tier two storage device. As depicted in FIG. 1, the storage device 100 has an associated controller 101, which manages access to the hard disk drives 104, a port 102, which connects the storage device 100 to the SAN 120 and a network interface card (NIC) 103, which connects the storage device 100 to the LAN 130. Similarly, the storage device 110 has a controller 111, a port 112, and a NIC 113, which perform similar functions to the controller 101, port 102, and NIC 103, described above with reference to the storage device 100.

In the exemplary embodiment depicted in FIG. 1, the storage devices 100 and 110 are connected to the servers 140 and 150. The server 140 is a document management server, which includes a central processing unit (CPU) 141, a memory (Mem) 142, a host bus adapter (HBA) 143 for retrieving and storing data to the storage devices 100 and 110 via SAN 120. Also, the document management server 140 has a network interface card (NIC) 144 for communicating with the storage devices 100 and 110 and the server 150.

The server 150, depicted in FIG. 1, is a storage device management server. The storage device management server 150 has a CPU 151, Mem 152, and a NIC 153. The storage device management server 150 connects to LAN 130 using the NIC 153. The storage device management server 150 manages the storage devices 100 and 110 and communicates with the document management server 140 using the LAN 130.

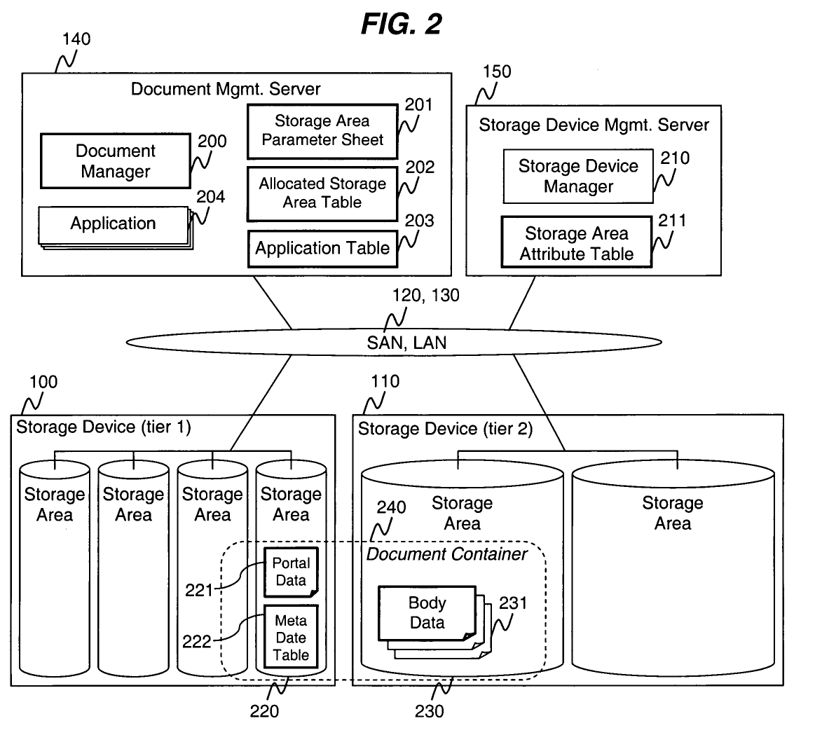

The above described hardware configuration is provided by way of example only and is not intended to limit the scope of the claims in any way. For example, more than two storage devices 100 and 110 may be provided. Every such storage device will be connected to the document management server 140. However, different storage device management servers 150 for managing various storage devices may be provided. Additionally, instead of the servers, one or more processors may be provided to manage the storage devices. Further, other networks may be used for communication between the servers and the storage devices. As would be understood by one of ordinary skill in the art, many other variations of the above-described architecture are within the scope of invention. Specifically, the inventive concept encompasses any hardware architecture currently known or future developed that can be configured to implement the functions described herein and, for example, the functions of the exemplary storage system described below with reference to FIG. 2.

FIG. 2 is a block diagram illustrating the architecture of the storage system according to an exemplary embodiment of the present invention. FIG. 2 depicts storage devices 100 and 110, and the servers 140 and 150, which are also shown in FIG. 1. The storage devices 100 and 110 have a number of physical disks and communicate with the document management server 140 and the storage device management server 150 via SAN 120 and LAN 130. As depicted in FIG. 2, the storage devices 100 and 110 have several storage areas. For purposes of simplicity, only one storage area in each device is labeled and described herein. However, it should be understood by those of skill in the art, that the inventive architecture may include multiple such storage devices and/or areas. In the shown exemplary embodiment, the storage device 100 has a storage area 220 and the storage device 110 has a storage area 230. The storage areas 220 and 230 can be configured to have a desired size and configuration. For example, the appropriate RAID level may be set for these storage areas 220 and 230.

Two or more of the storage areas allocated with the two storage devices 100 and 110 logically form a document container for storing various types of data. In the example depicted in FIG. 2, the storage areas 220 and 230 logically form a document container for storing portal data 221 and one or more respective body data 231. That is, the portal data 221 is stored in the storage area 220 and the corresponding one or more body data 231 is stored in the storage area 230.

The portal data 221 is data that represents abstract, essential part or summary of a document stored in the aforementioned logical document container. The portal data 221 may, for example, be a thumb-nail image of one or more photographs or an abstract of an article. The portal data is stored in the storage area 220 of the tier one storage device 100. In the shown exemplary embodiment, the storage device 100 is a high access speed storage device that allows a user or a client application to quickly retrieve the portal data 221. Generally, the size of the portal data 221 is smaller than the size of the corresponding body data 231. Thus, the portal data 221 can be stored in a smaller, faster storage, area 220 of the storage device 100.

The body data 231 is data that represents the body of a document or an attachment to a document. For example, the body data may be an actual photographic image (as opposed to a thumbnail image), or a content of an article. The body-data 231 is stored in the storage area 230 of tier two storage device 110. In the exemplary embodiment of the invention described herein, the storage device 110 is a low cost storage device with a high capacity storage area but slow access speed. Generally, a user can tolerate a longer waiting period to retrieve the actual body data. Thus, the body data does not have to be stored in the expensive high access speed storage device such as the storage device 100. Having separate storage areas of different devices for the portal and body data allows for more efficient use of the available storage resources. That is, the total cost of ownership of the storage system utilizing the inventive methodology is less than of a conventional system of equivalent storage capacity.

The document container 240 further includes metadata table 222, see FIG. 2. The metadata table 222 is a table which holds name, hierarchy and type information on the portal data 221 and the corresponding body data 231 of the document container 240. In the example depicted in FIG. 2, the metadata table 222 is stored in the storage area 220. However, the metadata table may be stored at some other storage location such as the storage area 230. It is preferable, however, that the metadata table is stored at same location as portal data 221.

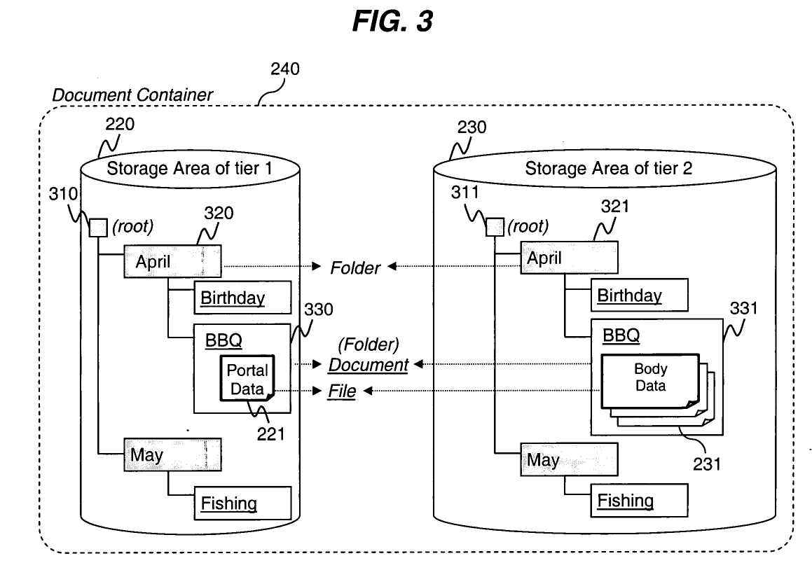

FIG. 3 provides detailed information on the structure of the document container 240, which stores the portal data 221 and body data 231. Specifically, FIG. 3 depicts a hierarchy of folders 320 in the storage area 220 of the tier one storage device and the corresponding hierarchy 321 in the storage area 230 of the tier two storage device. As depicted in FIG. 3, the folder hierarchy of the storage area 220 originates from the root folder 310 and has a number of subfolders, which include “April” and “May”. Each of the aforementioned subfolders may have their own subfolders. For instance, the subfolder “April” has folders named “Birthday” and “BBQ” (labeled 330 in FIG. 3), while the subfolder “May” has a folder “Fishing”. As depicted in FIG. 3, the storage area 230 in tier two storage device has a folder structure identical to the folder structure of the storage area-220 of the tier one storage device. Specifically, the area 230 includes a root folder 311, a subfolder “April” with subfolders “Birthday” and “BBQ”, and a subfolder “May” with a subfolder “Fishing”.

In the system shown in FIG. 3, documents are stored and managed using the hierarchical folders 320 of the tier one storage area 220 and also using hierarchical folders 321 of the tier two storage area 230. The hierarchy of folders and subfolders of the document container 240 is specified by the user, as explained in greater detail below. Once the folder structure has been so specified, the document manager 200 creates identical folder/subfolder hierarchies in both the storage area 220 and the storage area 230. For example, as depicted in FIG. 3, both storage areas 220 and 230 contain folder “April” with subfolder “BBQ”, with the “BBQ” subfolder of the storage area 220 storing the portal data, and the “BBQ” subfolder of the storage area 230 storing the body data. It should be noted that there may be multiple body data objects 231 corresponding to a single portal data object 221. These multiple body data objects 231 may be all stored in same folder of the tier two storage area 230 with the corresponding portal data 221 stored in the tier one storage area 220 under the identically named folders and subfolders within the folder hierarchy.

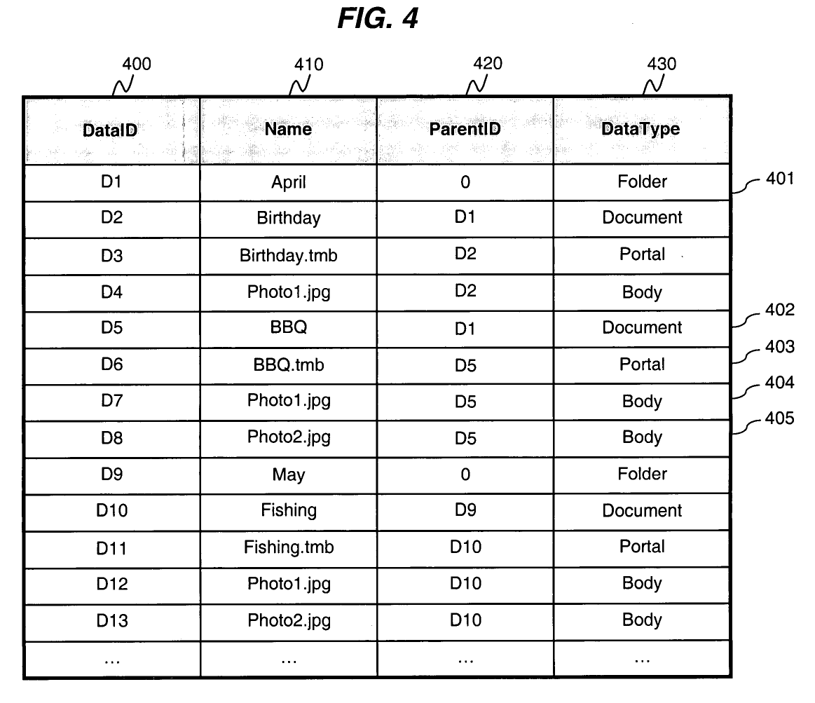

The folder hierarchy, depicted in FIG. 3, is located within the metadata table 222. An exemplary metadata table 222 is depicted in FIG. 4. The exemplary metadata table shown in FIG. 4 includes a data identifier (DataID) field 400, which uniquely identifies folders and subfolders in the folder hierarchy, as well the stored documents, including the body and portal data components thereof. The values in the field 400 are assigned by the document manager 200. The metadata table 222 also includes a column 410 containing the naming information for the folders, subfolders, as well as the stored documents. This naming information is specified by the users of the inventive system. The column 420 contains identifier (ParentID) of the parent folder or subfolder for a corresponding data object. For example, value of “0” in column 420 corresponds to root folder, value of “D2” in the row 401 corresponds to the first-level folder “April.” Finally, the metadata table 222 has a column 430 called DataType for storing the information on the type of the corresponding data object. The value in that column indicates whether the corresponding item is 1) a folder , 2) a document (folders storing portal or body data), 3) portal data such as thumbnails, or 4) body data such as the actual photographic image.

For instance, row 401 of the table depicted in FIG. 4 contains a record corresponding to the folder named ‘April’, which is a subfolder of the root folder. Row 402 represents document named ‘BBQ’ having a ParentID value of ‘D1’, which identifies its parent folder as “April.” Rows 403, 404, and 405 represent portal data object “BBQ.tmb” and body data objects “Photo1.jpg” and “Photo2.jpg”, respectively, each having the ParentID value of “D5”, indicating that all of them are located in the parent folder ‘BBQ’.

The storage areas 220 and 230 are managed by the storage device management server 150 shown in FIG. 2. The storage device management server 150 includes a storage device manager 210 and a storage area attribute table 211. The storage device manager 210 controls overall operation of the respective storage devices including storage devices 100 and 110. The storage device manager 210 manages various operations of the inventive system including, without limitation, storage area creation, storage allocation to various hosts as well as storage masking. The storage device manager 210 enables the document management server 140 to set the desired size and performance characteristics for the storage areas necessary to store the data objects. The storage area attribute table 211 holds records containing attributes of various storage areas, such as storage areas 220 and 230. Specifically, the storage area attribute table 211 contains a separate record for each storage area managed by the storage device manager 210. The attribute table records may include information on the stored data size, RAID level, cost per capacity unit, data access bandwidth, etc. The records may also include information on whether or not a specific storage area is allocated to a specific host. The storage area attribute table 211 is managed by the storage device manager 210.

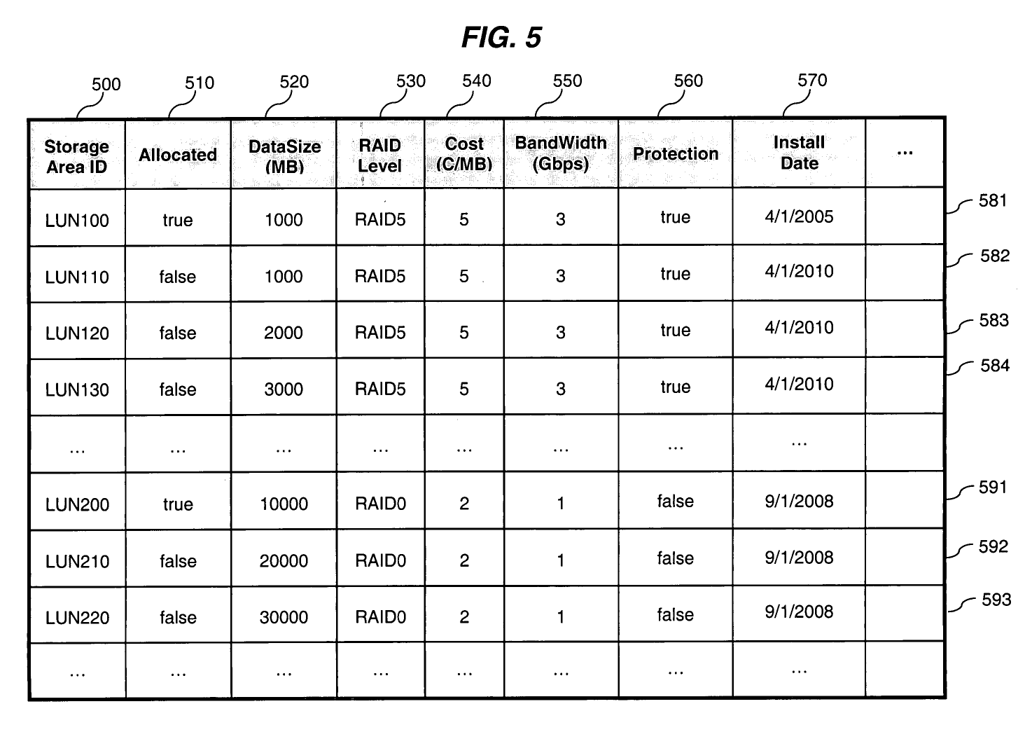

FIG. 5 depicts an exemplary embodiment of the storage area attribute table 211 with columns 500, 510, . . . , 560, and 570 and rows 581, 582, . . . , 592, and 593. As shown in FIG. 5, the storage area attribute table 211 includes a column 500 containing a storage area identifier (ID), which uniquely identifies the storage area. For example, the storage area identifier may include Logical Unit Number (LUN) 100, 110, . . . , 210, 220.

As depicted in FIG. 5, the storage area attribute table 211 may also contain an allocation column 510. The value stored in the allocation column 510 indicates whether a particular storage area is allocated to a particular host. The true value indicates that the storage area has been allocated, while the false value corresponds to unallocated storage areas. For example, in the embodiment shown in FIG. 5, the storage areas with LUNs 100 and 200 have been allocated (the value in the corresponding field of the allocation column 510 is “true”), whereas all other storage areas are not allocated (the values in the corresponding fields are “false”).

The storage area attribute table 211 further includes a column 520 indicating the size (in MB) of the storage area, a column 530 indicating RAID level, a column 540 indicating cost (per megabyte), a column 550 indicating data access bandwidth (in Gbps), a column 560 indicating whether the storage area has a protection feature, and an installation date column 570 indicating the installation or allocation date. For example, the storage area with a storage identifier value of LUN100 (row 581) has a data size value 520 of 1000 MB, RAID level of 5, cost 540 of 5 (C/MB), bandwidth 550 of 3 Gbps, and install date 570 of Apr. 1, 2005. The data protection feature 560 may include read/write protection flag, which may be represented using a Boolean value. For instance, the storage area with a storage identifier value of LUN100 has a Boolean value “true” in the data protection field 560, indicating that reading and writing accesses are allowed.

One of ordinary skill in the art will readily appreciate that the storage area attribute table 211 may have other columns representing additional or alternative attributes of the corresponding storage areas. The above-described columns are provided by way of example only and one of ordinary skill in the art would readily recognize that many variations of the above-described attributes and table structures are within the scope of the invention.

The storage device manager 210 manages various storage areas within the storage devices 100 and 110 based on the parameters stored in the storage area attribute table. The document management server 140, depicted in FIG. 2, includes a document manager 200 that manages the documents as well as one or more applications 204, providing the inventive system with data viewing capability. Moreover, the document management server 140 includes a storage area parameter sheet 201, allocated storage area table 202, and an application table 203, which are used by the document manager 200 and the application 204.

The document manager 200 allocates two different types of storage areas via the storage device manager 210 of the storage device management server 150 and creates a document container 240 to store specific category of documents. i.e., portal data together with the corresponding body data. Upon receipt of the document containing the portal data and the body data, the document manager 200 separates the portal data 221 from the body data 231 and writes each of them into a storage location in an appropriate storage area. The document manager 200 also invokes the application 204, which enables the user to view the information stored by the inventive system.

In order to allocate the required storage areas, the document manager 200 transmits the storage area parameter sheet 201 to the storage device manager 210 requesting the storage device manager 210 to allocate the storage areas with the parameters and attributes specified by the document manager 200 in this storage area parameter sheet. The document manager 200 transmits this storage area parameter sheet 201 during the creation of a new document container 240. In an embodiment of the inventive system, the storage area parameter sheet 201 is not a persistent data table but a temporary data sheet that is used by the document manager 200 in the process of requesting storage areas.

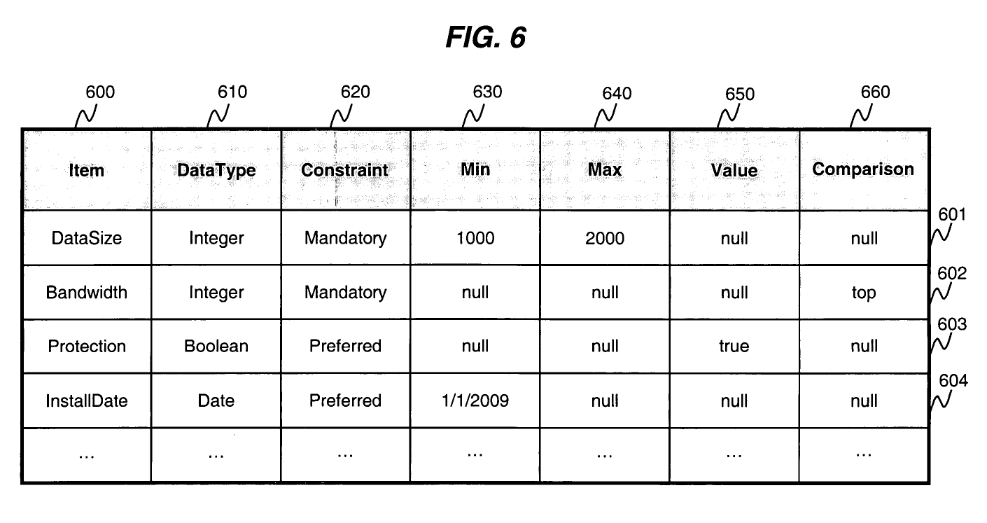

FIG. 6 depicts an exemplary storage area parameter sheet 201 having columns 600, 610, . . . , 650, 660 and rows 601, 602, 603, and 604. The document manager 200 does not need to specify each and every attribute of the storage area to be allocated but may instead specify only the necessary and preferred attributes. Thus, if value of a particular attribute or characteristic of the storage area is unimportant, this attribute or characteristic may be omitted from the storage area parameter sheet.

In the exemplary storage area parameter sheet depicted in FIG. 6, the document manager 200 specifies values only for the data size, bandwidth, protection feature, and installation date, and not for all of the attributes listed in the storage area attribute table of FIG. 5. Column 600 specifies the name of the storage area attribute or characteristic for which values are provided. Column 610 specifies the data type for the values of the attribute or characteristic. Column 620 specifies the constraint (whether this item is mandatory or just a preferred attribute). Column 630 represents a minimum numeric value that a specific attribute of the allocated storage area must have and column 640 represents the corresponding maximum numeric value. If a storage area with a specific value of a specific attribute is required, this value may be specified in column 650. Finally, column 660 is labeled as comparison column, which represents the importance of the attribute with respect to the other attributes i.e., the priority of the attribute with respect to other attributes in the storage area parameter sheet.

For instance, row 602 in FIG. 6 provides a criteria for attribute “Bandwidth”, which is specified as having integer type, mandatory applicability in allocating a storage area, with minimum, maximum, and exact value not specified, and with the comparison having value of “top”, indicating that this is the most important attribute for allocating the storage area. Based on the above-specified parameters of the attribute “Bandwidth”, the storage device management server 150 will allocate a storage area of an appropriate storage device with the highest speed currently discovered in the environment (i.e., tier one storage device 100). Row 603 in FIG. 6 directs the storage device manager 210 of the storage device management server 150 to choose a storage area that has a ‘Protection’ feature. However, if the storage area with the highest access speed (bandwidth) does not have a protection feature, this storage area will still be selected, because the protection feature is designated as preferred and not mandatory. Accordingly, using the storage area parameter sheet 201, the document manager 200 specifies the data storage to the storage, device manager 210. The document manager 200 may, in turn, obtain the desired attribute values for the storage areas from the user or may determine the needed attributes based on the characteristics of the storage container.

The document manager 200 also manages all of the storage containers in its environment using the storage area allocation table 202. The storage area allocation table 202 holds records providing detailed information on the storage allocation for each document container 240 stored by the inventive system. Specifically, for each such document container, the table provides the name thereof as well as the identify of storage areas that are used to store the portal data 221 and body data 231 of the document container 240.

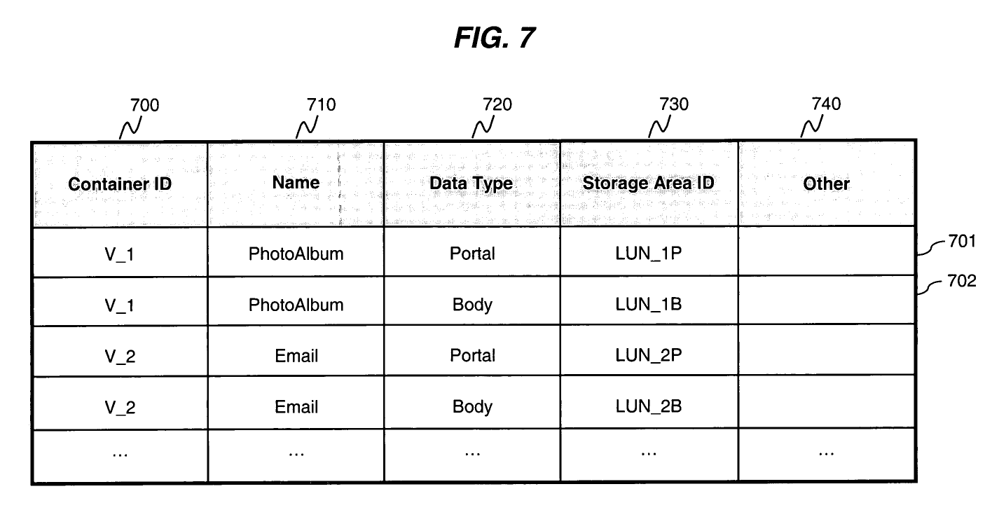

FIG. 7 depicts an exemplary organization of the storage area allocation table 202. As depicted in FIG. 7, the storage area allocation table has a container ID column 700, container name column 710 (the name of the folder or subfolder in the hierarchy to which the container corresponds), data type column 720 (specifying whether the data is portal or body), storage area ID column 730 (providing information on where the data is stored), as well as a column 740 for storing other appropriate characteristics of the container. Other characteristics of the container stored in the allocation storage area table 202 may include a relationship column (which specifies other containers to which the data is applicable) and/or a migration level column containing information on the priority of migrating data to another device, which is explained in greater detail below with reference to the second exemplary embodiment of the inventive concept.

For example, as depicted in FIG. 7, the row 701 corresponds to a portal data object (data type column 720) stored in the storage area LUN_{—}1P (storage area ID column 730), under the photoAlbum subdirectory (name column 710), which is part of the container V_{—}1 (Container ID column 700). Furthermore, the value in the column 740 may indicate that the portal data cannot be migrated to another storage device even when the current storage device is full (e.g., the value of migration level may be set to 0). The column 740 may also indicate that this portal data is also related to the container V_{—}3 (not shown). The table in FIG. 7 is shown by way of an example only and is not intended to limit the scope of the invention in any way.

The document manager 200 depicted in FIG. 2 also manages the application table 203. The application table 203 holds records that specify which application 204 can be used to open objects of various data types, such as text, bitmap, email, and so on. FIG. 8 illustrates an exemplary embodiment of the application table 203. As depicted in FIG. 8, the application table 203 includes a file extension column 800 and a corresponding application column 810. The value in the application column 810 specifies a path to an application that is used to open data files having extensions specified in the corresponding row of the extension column 800. For instance, in FIG. 8, row 801 represents a record indicating that the application named ‘AAAnotepad.exe’ should be invoked when the user requests to view a document data (either portal data or body data) which,has a file extension of “txt”. Accordingly, the document manager 200 manages all aspects including creation, editing, deletion, addition, and viewing of the containers and data therein.

That is, when the user requests the inventive system to create a document container 240 of a specific size, the document manager 200 sends a request to the storage device manager 210 requesting it to allocate a high, access speed storage area 220 for the portal data 221 and to allocate a low cost storage area 230 for the body data 231. Once the above storage areas have been allocated, the corresponding entries are added to the storage area allocation table 202 (see FIG. 7). When the user requests to store a document in the document container 240, the document manager 200 stores the specified portal data 221 in the storage area 220 and the body data 231 in the storage area 230. Also, the document manager 200 adds records describing the new portal and body data to the metadata table 222 (see FIG. 4). In addition, when the user requests to browse the portal or body data, the document manager 200 refers to the allocated storage area table 202 and the metadata table 222 to obtain the desired file (data), which is stored in the storage area 220 or 230. When the user uses the inventive system to view a specific data file, the document manager 200 invokes the application 204, which is specified in the application table 203.

Because the portal data is stored in a high access speed storage area, the response time for browsing through the portal data is shortened. Moreover, because the body data, which is generally much more voluminous than the portal data, is stored in a storage area allocated on a cheap media, the storage resources are efficiently used and the total cost of ownership of the inventive document management system is reduced.

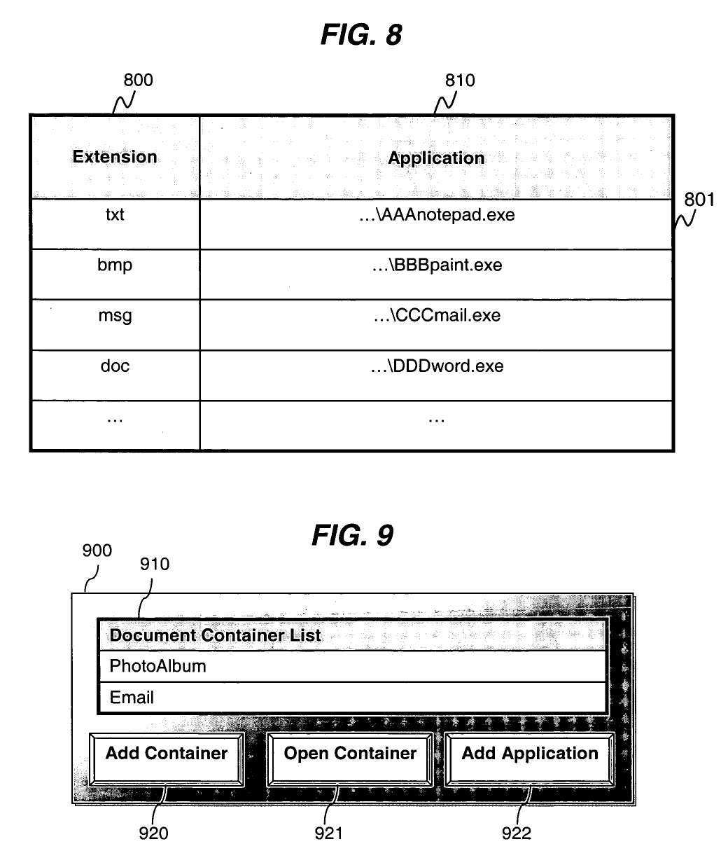

In addition, the user of the inventive system is provided with flexibility in creating and managing document containers. Specifically, the user is able to manipulate almost every aspect of this document management system. In the exemplary embodiment of the present invention, the user is provided with a container management user interface depicted in FIG. 9. For example, when the user invokes the main application of the document management system, the document manger 200 displays the interface depicted in FIG. 9.

The container management user interface 900 is illustrated in FIG. 9. This interface provides the user with a list 910 of all existing document containers. For example, the container list 910 depicted in FIG. 9 includes containers “PhotoAlbum” and “Email”. Any of the listed existing containers may be opened by simply selecting the appropriate container and activating the Open Container button 921. When a container is opened, the user is provided with another user interface for managing folders and data of the container.

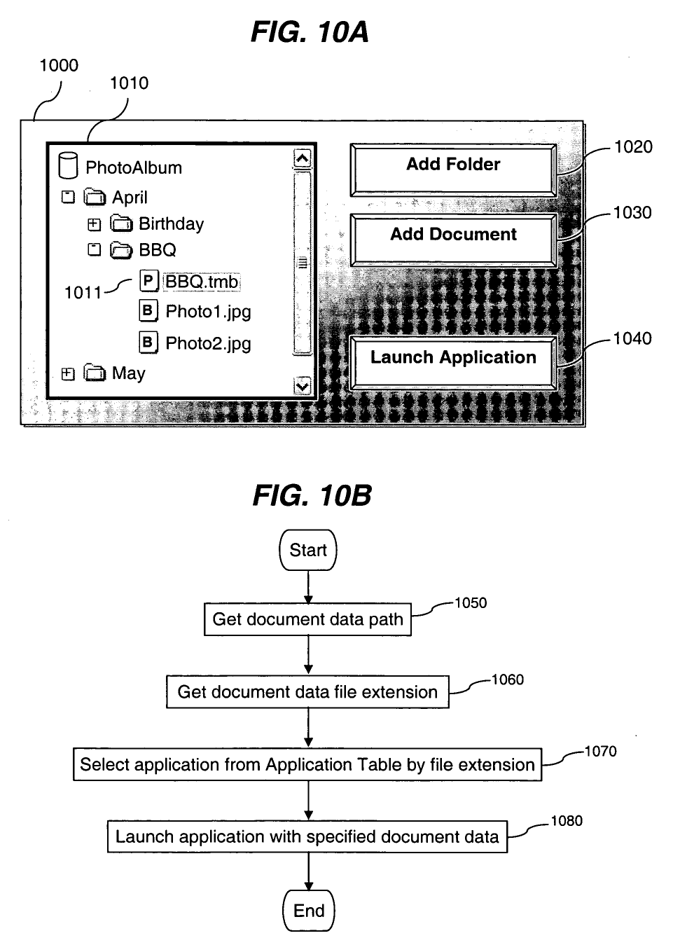

For example, when the user opens the “PhotoAlbum” document container shown in FIG. 9, the document manger 200 provides the user with a new user interface such as a document management interface depicted in FIG. 10A. As depicted in FIG. 10A, the user is provided with a hierarchical document tree 1010. The tree 1010 is a hierarchical representation showing the folders, subfolders and stored document data corresponding to the selected document container. For example, the document or data tree 1010 of FIG. 10A illustrates the selected document container “PhotoAlbum” having subdirectories “April” and “May” and having folders “Birthday” and “BBQ”. In the hierarchical document tree 1010, the subdirectories “April” and “May” stem from the root folder and the folders “Birthday” and “BBQ” are second level folders that stem from the subfolder April. The user can navigate the hierarchical tree 1010 by expanding or compressing one or more of the folders and subfolders and selecting documents or other folders within the expanded subdirectory or folder.

As depicted in FIG. 10A, the user has expanded the subfolder April (first level) and the subfolder BBQ (second level). The subfolder BBQ has portal data “BBQ.tmb” 1011 and body data “Photo1.jpg” and “Photo2.jpg”. To facilitate user's ability to easily navigate the data tree, each item may further be labeled with an icon: a folder icon for folders and subfolders, a “P” icon for portal data, and a “B” icon for the body data, see FIG. 10A.

In order to view a particular data object, the user selects the corresponding object and actives launch application button 1040. As depicted, in FIG. 10A, the user selected portal data object 1011 depicted in the hierarchical document tree 1010 and activated the launch application button 1040. The document manager 200 then invokes an application corresponding to the selected data (by using the application table 203 that maps the type of data to an application) and displays the content of selected document data e.g., thumb nails of photos in the folder ‘BBQ’. In an embodiment of the inventive system, while the portal data is being viewed by the user, the document manager 200 may pre-fetch the corresponding body data to speed up access to the body data. The description of the above user interfaces is provided by way of an example only and one of ordinary skill in the art would readily recognize that other variations thereof are within the scope of the invention.

FIG. 10B illustrates an exemplary process for launching an application to view selected data. The process depicted in FIG. 10B may be launched by activating the launch application button 1040 depicted in FIG. 10A or by double-clicking on the appropriate data object. In operation 1050, the document manager 200 obtains the document name and data path, based on the user selection on the hierarchical tree 1010. The document manager 200 then extracts a file extension character string from the obtained data file name, in operation 1060. In operation 1070, the document manager 200 selects a record from the application table 203 corresponding to the extracted extension character string and obtains from this record the appropriate application file path and name. In operation 1080, the document manager 200 invokes this application to view the selected content. If the extracted extension does not match any extensions stored in the application table 203, an error may be output. Alternatively, the user may be prompted to specify the application for this data type. Yet alternatively, a default application may be called. As will be appreciated by those of skill in the art, many other error handling techniques are within the scope of the inventive concept.

Accordingly, the user may view various data using pre-configured application without much effort on user's part. Not only can the user view the data with the selected application, the user also has flexibility in managing the documents or data in the container. That is, the user may manage each container by deleting, editing or adding folders, subfolders, portal data, and body data. For example, the user may store new document in the container by activating add document button 1030 (depicted in FIG. 1A). With activating the add document button 1030, a new user interface may be provided that will enable the user to store a set of documents under the folder currently selected by the user within the hierarchical tree 1010.

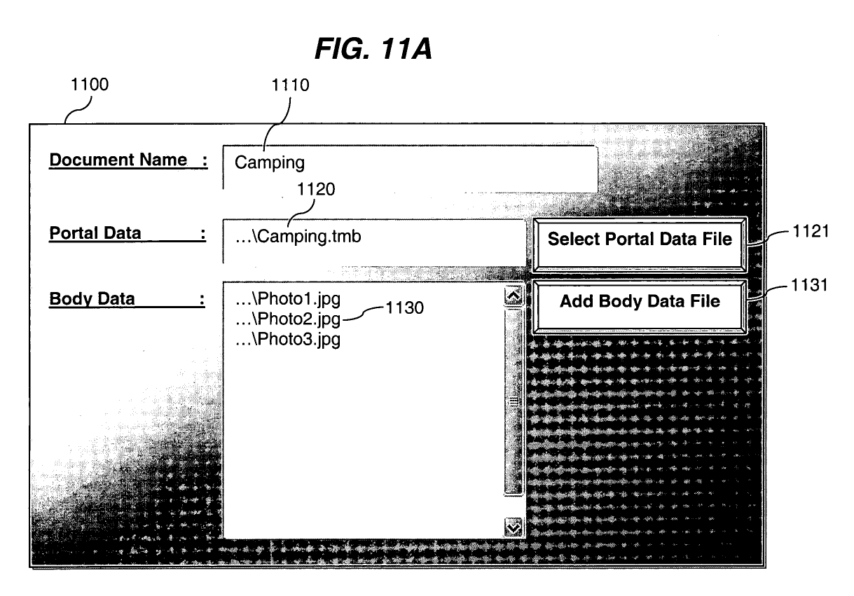

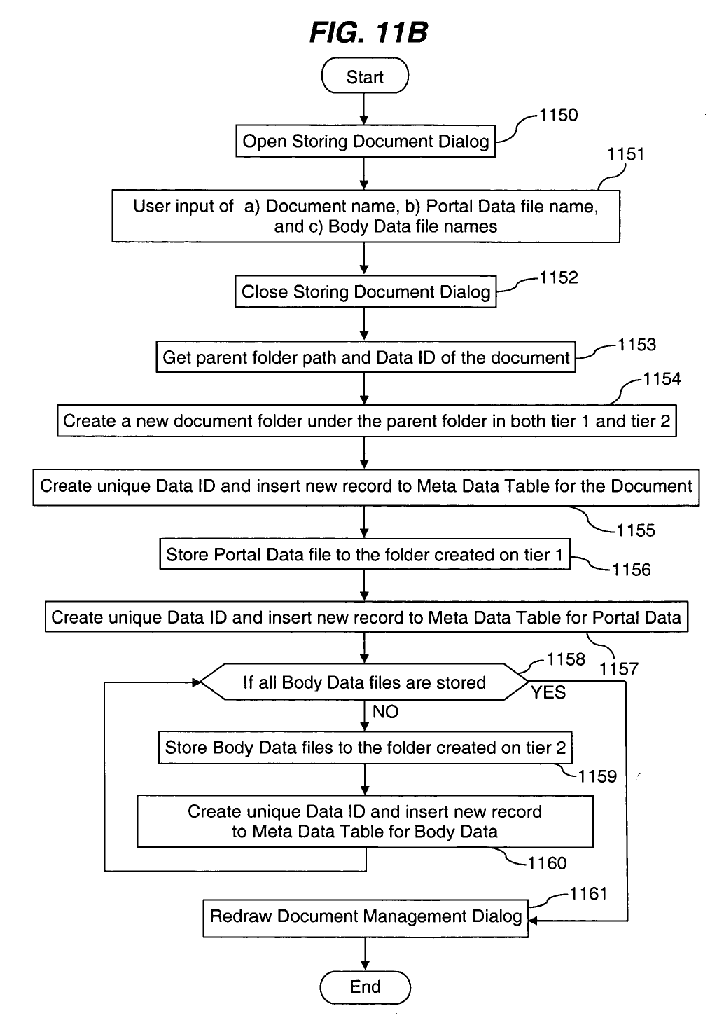

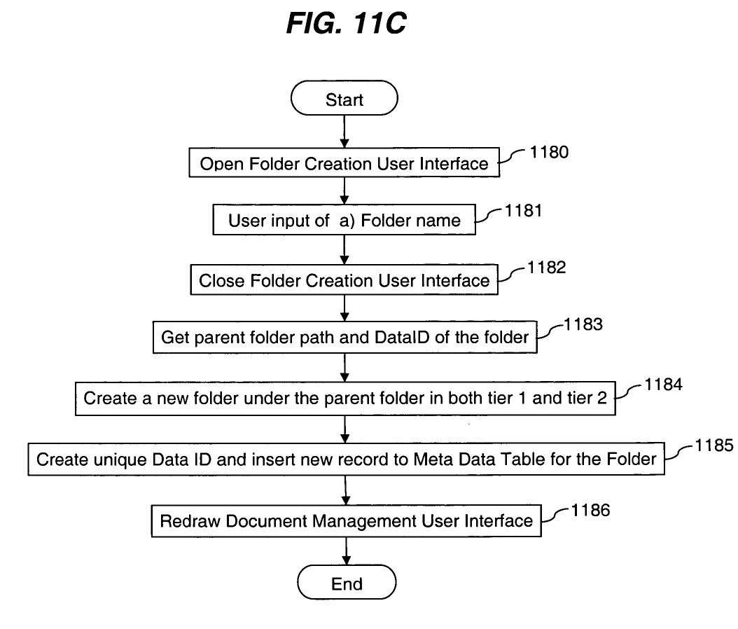

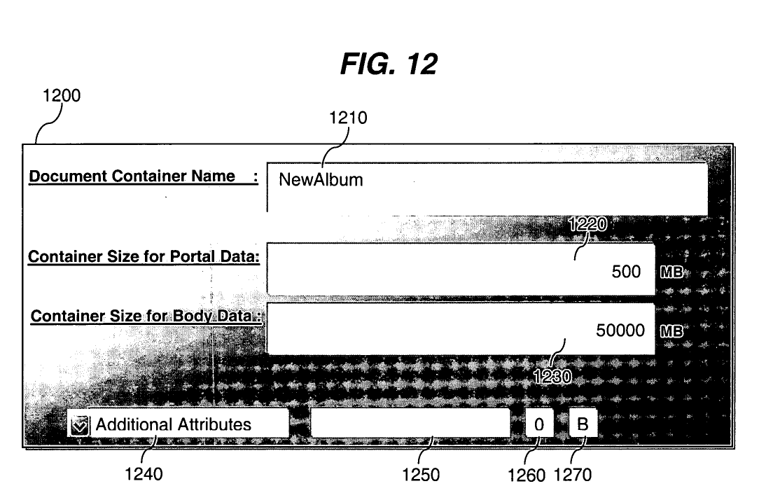

For instance, when the user needs to add additional documents, the user activates the “Add Document” button 1030. As a result of depressing the button 1030, a new user interface 1100, depicted in FIG.11 A, may be presented to the user. This user interface is provided for adding or storing data to a particular container.

In FIG. 11A, the adding or storing document interface 1100 comprises a document name input area 1110, portal data file name display area 1120, select portal data file button 1121, body data file name display area 1130, and add body data file button 1131. In the document name input area 1110, the user may type in the name of the document or folder to be included in this container.

With activating the select portal data file button 1121, a file selecting dialog (which may be operating system (OS) dependent) will appear. In this selecting dialog, the user may select a file for the portal data and the name of the selected file is displayed in the portal data file name display area 1120. Additionally or alternatively, the user may type in the name of the portal data into the portal data file name display area 1120. Accordingly, one or more of the portal data objects may be added. In the example depicted in FIG. 11 A, only one portal data object is added.

Similarly, with activating the add body data file button 1131, the file selecting dialog (which may be OS-dependent) is launched. This dialog may be used by the user to add a file containing the body data. The name of the added file is appended to the file list displayed in the area 1130. In this manner, one or more of the body data files may be added.

FIG. 11B illustrates an exemplary embodiment of a process for storing data. The process depicted in FIG. 11 B is launched when the user activates the add document button 1030 (depicted in FIG. 10A). In operation 1150, user interface or dialog for storing or adding data (depicted in FIG. 11A) is presented to the user. In operation 1151, the user manipulates various fields in the launched interface to input folder name, as well as the names of one or more of portal and body data files. In operation 1152, the user interface for adding data is closed e.g., the user clicks save (not shown).

In operation 1153, the document manager 200 obtains a folder path and data ID of the parent folder (from the metadata table 220) in relation to the data being currently stored. In operation 1154, new user-specified folders are created under the parent folder of both tier one storage area and tier two storage area. In operation 1155, a new unique data ID is generated and a new record is added to the metadata table 220. The new record for the added folder includes the newly generated data ID, user-specified document name, obtained data ID of parent folder, and DataType of “Document” (folder).

In operation 1156, the portal data file specified by the user is written to the newly created document folder of tier one storage area. Next, in operation 1157, a new unique data ID is generated and a new record is added to the metadata table 220. The new record for the portal data includes the created data ID, user-selected file name, data ID of this document folder, and the DataType value of “Portal”. If more than one portal data object is added, the operations 1155 to 1157 will loop until every portal data has been stored, similar to the loop with respect to the body data explained below.

That is, the process loops through operations 1158 to 1160 until every user specified body data has been stored. In operation 1158, a check is performed to see if all body data files have been stored. In operation 1159, the body data file specified by the user is stored to the newly created document folder of tier two storage area. In operation 1160, the document manager 200 creates a new unique data ID. Then, the document manager 200 inserts a new record into the metadata table for the body data. The new record includes the created data ID, user-selected file name, the data ID of this document folder, and DataType of “Body”.

In operation 1161, the document management user interface depicted in FIG. 10A is redrawn and presented to the user. The redrawn document management user interface includes the newly added data object in the hierarchical data tree 1010. Accordingly, the user may easily manage the containers together with their folders and data via simple and self-intuitive user interfaces.

Moreover, -as depicted in FIG. 10A, the user may add a folder or subfolder by activating add folder button 1020. When the add folder button 1020 is activated, a new user interface is provided in which the user specifies the name of the new folder or subfolder, as well as the location of the folder or subfolder in hierarchy, and then saves this folder or subfolder, for example by activating an appropriate button. If the location of the new folder or subfolder within the hierarchy is not specified, by default, the new folder or subfolder will be created under the folder currently selected by the user within the hierarchical tree 1010 e.g., a new subfolder under the folder BBQ will be created. If no folders were selected, then by default, the new subdirectory will be a level one subdirectory, such as new subdirectory “June”. Accordingly, the hierarchical data tree 1010 will be refreshed and a new folder or subdirectory will be displayed within the hierarchical data tree 1010.

Specifically, as illustrated in FIG. 11C, the process for creating a folder starts with the user activating the add folder button 1020 on the document management user interface depicted in FIG. 10A. In operation 1180 of FIG. 11C, the folder creation user interface is opened and the user inputs the folder or subdirectory name in operation 1181. Next, in operation 1182, when the user saves the selection, for example by clicking the save button (not shown), upon which the folder creation user interface is closed.

The document manager 200 then obtains the folder path and data ID of the parent folder for the folder or subdirectory being currently created, in operation 1183. For example, the parent folder may be determined by the location on the hierarchical tree prior to the selection of the new folder button. In operation 1184, the new folder or subfolder with the user-specified name is created under both the parent folder of both tier one and tier two storage areas. In operation 1185, the document manager 200 generates a new unique data ID, and then it adds a new record into the metadata table. The new record includes the created data ID, user-specified folder or subdirectory name, obtained data ID of parent folder, and DataType of “Document” (data type of the folder or subdirectory). In operation 1186, the screen of document management user interface 1000 (FIG. 10A) is redrawn with the data tree containing the updated folder information.

Next, returning to FIG. 9, which depicts an exemplary user interface for managing document containers, the user may also add a new container by activating the add container button 920. When the add container button 920 is activated, a new user screen, depicted in FIG. 12, for adding a new document container is provided.

In FIG. 12, an exemplary new document container creation user interface 1200 is depicted. New document container creation user interface 1200 comprises a document container name input area 1210, portal data container size input area 1220, body data container size input area 1230, and other attributes selection 1240 with input area 1250 and mandatory or preferred input area 1260. The document container name input area 1210 can be used to specify the name of newly created document container. The portal data container size input area 1220 is provided to specify the size of the storage area in which the portal data of the documents will be stored. The body data container size input area 1230 is provided to specify the size of storage area in which the body data of the documents will be stored. The other attributes selection 1240 is a drop down menu from which the user may select an attribute and specify this attribute in the input area 1250. The user may sequentially select the desired attributes from the attribute selection 1240 and specify them in the blank are 1250. Other attributes, by way of an example, may specify the access speed of the storage area, indicate whether data is to be protected (e.g., read only access), indicate whether data can be migrated (migration is discussed further below). Also, for each attribute specified, in the second input area 1260, the user may specify that the attribute is mandatory (value “1”) or preferred (value “0”) and, in the third input area 1270, whether this attribute corresponds to the storage area of the portal data (“P”) or to the storage area of the body data (“B”). By default, the value of a user specified attribute may be set to “preferred” but the user can change the attribute value to “mandatory.”

Based on the criteria or attributes specified by a user using the user interface 1200, the document manager 200 creates a storage area parameter sheet 201 and transmits it to the storage device manager 210. It should be noted, that the storage area parameter sheet will have a row for every attribute specified by the user, and may have some additional attributes automatically added by the document manager based on the user-specified attributes and values. The storage device manager 210 refers to the storage area attribute table 211, communicates with the storage devices 100 and 110 and allocates the required storage area.

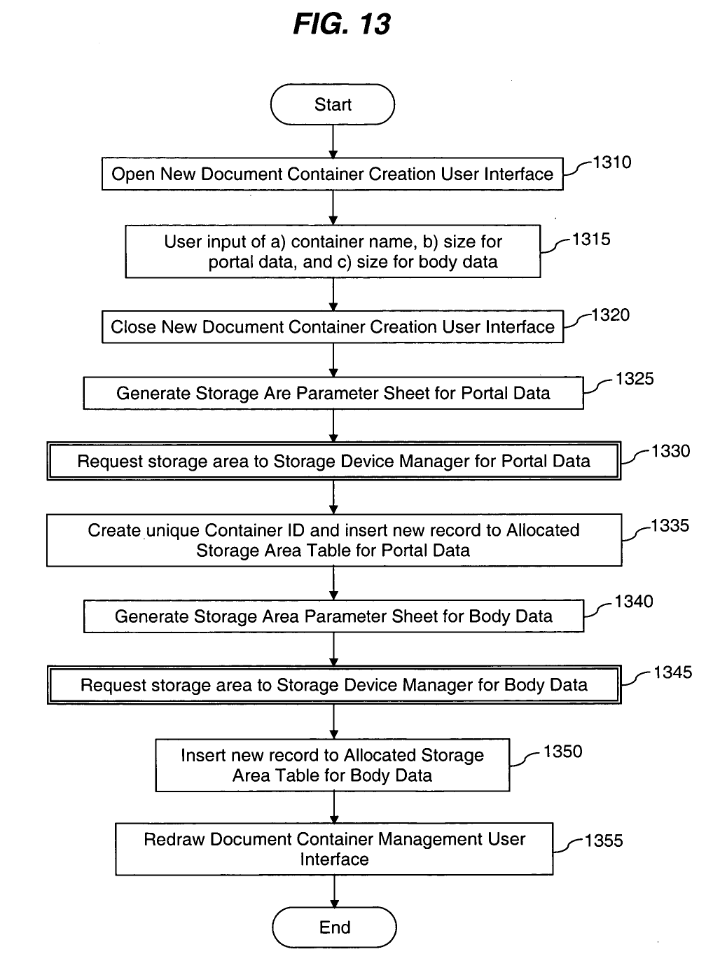

FIG. 13 depicts an exemplary process flow for creating a new document container. As illustrated in FIG. 13, the process is launched with the user activating the add container button 920 (depicted in FIG. 9). In operation 1310, a new container creation user interface 1200 (depicted in FIG. 12) is opened. In operation 1315, the user inputs attributes of the new document container (using 1210 . . . 1270 in FIG. 12). Once the user enters all of the desired/preferred attributes and directs the inventive system to create a new container e.g., by clicking the “save” button (not shown), the new container creation user interface 1200 is closed, in operation 1320.

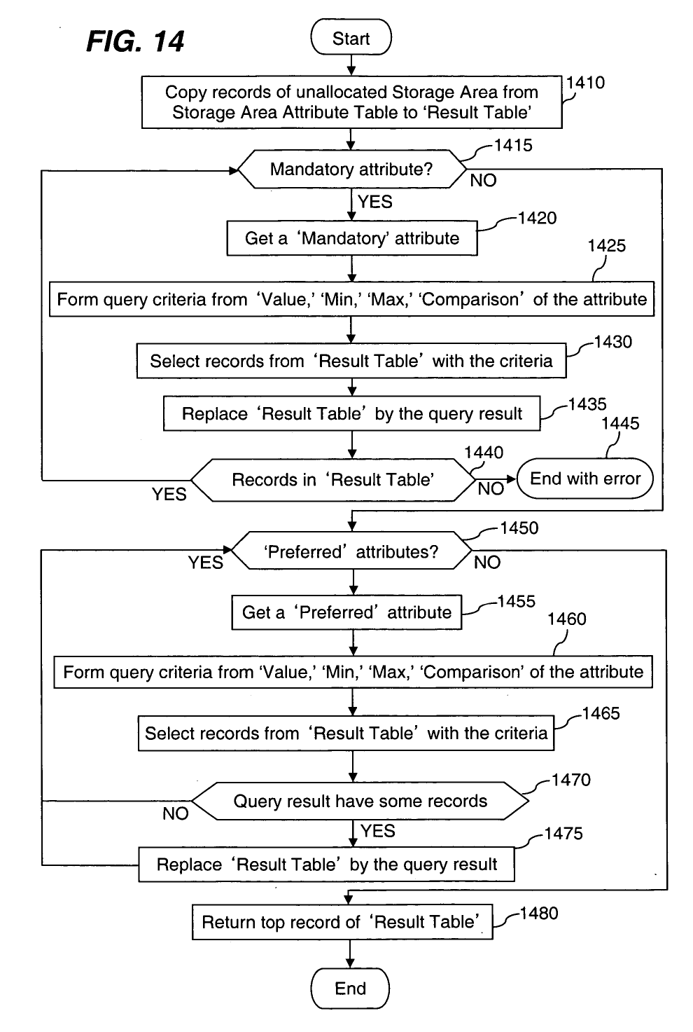

In operation 1325, the document manager 200 separates attributes specified for the portal data from the attributes specified for the body data and generates storage area parameter sheet 201 for the portal data only. Next, the document manager 200 passes the generated parameter sheet to the storage device manager 210, in operation 1330. The process flow for allocating a desired storage area by the storage device manager 210 is described below with reference to FIG. 14. The attribute criteria for the portal data should at least have the desired data size information specified by the user in operation 1315 and a request for the highest access speed storage area that is available within the environment.

At operation 1335, the document manager 200 creates a new unique container ID, and a new record in the allocated storage area table. The new record includes the created container ID, user-specified container name, DataType having value of ‘Portal’, and the storage area ID (obtained from the storage device manager 210). Other fields may also be designated such as migration level, and relationship to other container e.g., if the body data is also data of another container.

In operation 1340, the document manger generates a storage area parameter sheet 201 for the body data and passes it over to the storage device manager 210, in operation 1345. The attribute criteria for the body data specified in the parameter sheet 201 should contain at least the user-specified area size and a request for the lowest cost storage area that is available within the environment. The process flow for allocating the desired storage area by the storage device manager 210 is analogous to the allocation of desired storage area for the portal data and is described below with reference to FIG. 14.

Next, in operation 1350, the document manager 200 creates a new record in the allocated storage area table using the container ID already generated for the portal data, user-specified container name, data type value of ‘Body’, and the appropriate storage area ID (obtained from the storage device manager 210). Other fields may also be designated, such as the migration level, and the relationship to other container e.g., if the body data is also part of another container. In operation 1355, the document container management user interface (depicted in FIG. 9) is redrawn and the newly created container is displayed in the document container list 910.

FIG. 14 illustrates a flow chart for allocating a storage area by the storage device manager 210, according to an exemplary embodiment of the present invention. The allocation of the storage area is managed by the storage device manager 210 upon the receipt of the storage area parameter sheet 201 from the document manager 200 in operations 1330 and 1345 of FIG. 13.

As illustrated in FIG. 14, in operation 1410, the storage device manager 210 accesses the storage area attribute table 211 and copies the records corresponding to unallocated storage areas to a result table. Next, the process loops in operations 1415 to 1440 until every mandatory attribute specified in the storage area parameter sheet 201 has been processed. That is, in operation 1415, a check is performed to see if there are any unprocessed mandatory attributes. If there are unprocessed mandatory records (yes), the process proceeds to operation 1420. In operation 1420, the first or next unprocessed mandatory attribute is obtained from the storage area parameter sheet. In operation 1425, a query criteria from “value”, “min”, “max”, and comparison fields of the storage area parameter sheet is formed. In operation 1430, records from the result table that match the formed query criteria are selected. In operation 1435, the result table is replaced with only records that matched the formed query criteria. Next, in operation 1440, a check is performed to determine whether the result table is empty. If the result table is empty, in operation 1445, an error is returned. The error indicates that no storage area is available that meets the user criteria. If the results table contains at least one record, the process returns to operation 1415. The loop continues from operation 1415 to 1440 until every mandatory attribute from the storage area parameter sheet has been processed.

When each mandatory attribute has been processed i.e., in operation 1415, the check returns a “NO” (no mandatory attributes), the process proceeds to operation 1450. The process loops in operation 1450 to 1475 until every preferred attribute has been processed. Accordingly, in operation 1450, if there is an unprocessed preferred attribute (yes), the process proceeds to operation 1455.

In operation 1455, the first or next unprocessed preferred attribute is obtained from the storage area parameter sheet 201. In operation 1460, a query criteria from “value”, “min”, “max”, and comparison fields of the storage area parameter sheet 201 is formed. In operation 1465, records from the result table that match the formed query criteria are selected. If no records are found from the result table that match the formed query criteria in operation 1465, then in operation 1470, the process returns to the operation 1450 to process the next preferred attribute. The result table remains unchanged. Otherwise (if records are found in operation 1465), in operation 1475, the result table is replaced by the query results obtained in operation 1465 and the process returns to operation 1450 to process the next preferred record.

When there are no more unprocessed preferred attributes (a check for preferred attribute yields a “no” in operation 1450), the process proceeds to operation 1480. In operation 1480, the storage device manager 210 returns to the document manager 200 first record of the storage area on the result table and updates the storage area attribute table by designating the returned storage area as allocated. Accordingly, the process ends and the user has a document container having storage areas from various storage devices that meet the user's unique needs.

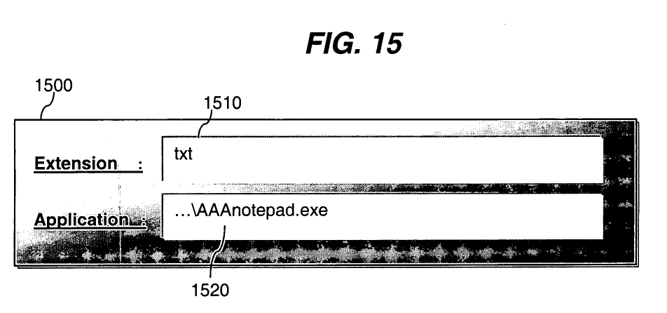

The inventive system also permits a user to add a new application. Specifically, upon activation of the “Add Application” button 922 (FIG. 9), a new user interface for application registration 1500 will appear, as depicted in FIG. 15. Using the user interface for application registration 1500, the user registers a new application 204 together with the corresponding file extension to view the appropriate type of document data. To this end, the application registration user interface 1500 comprises a document data file extension input area 1510 and application file input area 1520. The document data file extension input area 1510 can be used by the user to specify a character string of the file extension corresponding to the application to be registered. The application file input area 1520 may be used to specify name and filesystem location of the application which will allow the user to view the portal or body data of specific data type. When the user indicates that the input is complete, a new record is created in the application table 203 by the document manager 200.

The user interfaces depicted in FIGS. 9-11A, 12, and 15 are provided by way of an example only and not by way of limitation. One of ordinary skill in the art will readily recognize that the above described selections can be performed in a number of different ways. The present invention encompasses all various ways of specifying the above-described parameters, including those currently known or future developed.

In another exemplary embodiment of the inventive concept, to facilitate the efficient utilization of the storage resources, the document management system is provided with-a migration process. That is, in this exemplary embodiment, when no sufficient storage resources to accommodate the portal data are available, the old data is migrated to a different storage device, which is discovered in the environment. Accordingly, the storage area freed by the data migration process is allocated to store the portal data of new document(s). Many of the features of the structures, user interfaces, and process flows of this exemplary embodiment are analogous to the features of the structures, user interfaces, and processes previously explained in detail with reference to the first embodiment.

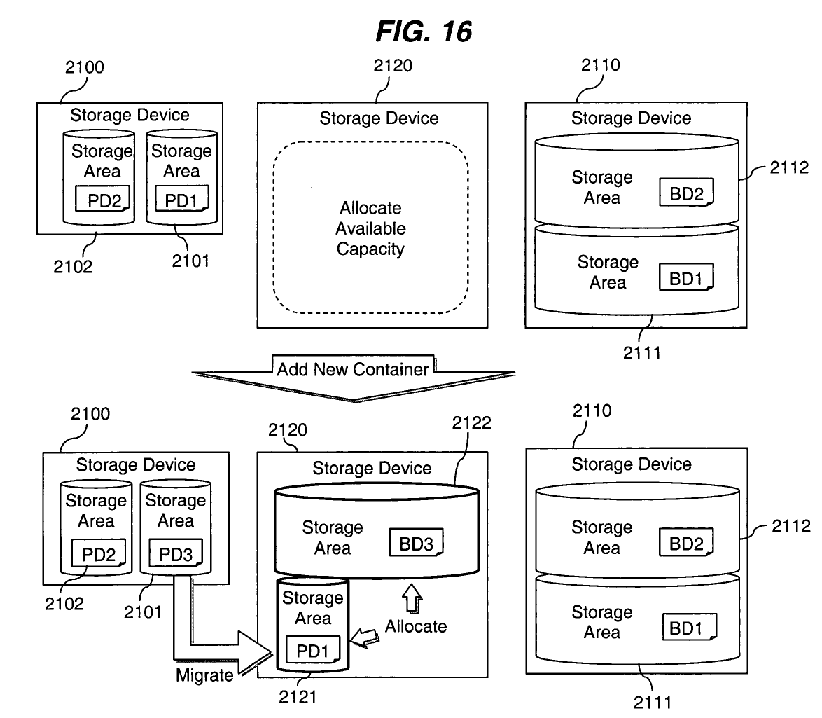

FIG. 16 illustrates an exemplary diagram illustrating the container migration process according to this second embodiment of the present invention. It should be noted that the main storage system components shown in FIG. 16 are analogous to the system components of the first embodiment of the inventive system, described in detail above with reference to FIG. 2. In FIG. 16, two storage devices 2100 and 2110 store two document containers. The first document container has portal data P1 stored in the storage area 2101 and body data B1 stored in the storage area 2111 and the second document container has portal data P2 stored in the storage area 2102 and body data B2 stored in the storage area 2112. The portal data P1 and P2 are stored in the storage device 2100, having high data access speed, while the corresponding body data B1 and B2 are stored in the storage device 2110, which is a cheap, low-speed storage device. In the shown example, it is assumed that the storage device 2100 is full and cannot store any more data.

The user, however, requests to add another document container having portal data PD3 and body data BD3. In the first exemplary embodiment of the inventive storage system described above, because the storage device 2100 is full and because there are no available storage devices that meet the user-specified characteristics for the portal data, an error code is returned.

In the illustrative embodiment shown in FIG. 16, however, the document manager 200 will start to push out old portal data from an expensive, high speed device to a cheaper storage device and use the storage space occupied by the old portal data to store the portal data of more recent documents.

As depicted in FIG. 16, a cheaper storage device 2120 is available. This device has available storage space but slower data access speed than the storage device 2100. To execute the migration process, the portal data P1 was originally stored in the storage area 2101 of the storage device 2100 but because it is the oldest portal data, it now migrates to the storage area 2121 of the storage device 2120. Also, the document manager 200 allocates a storage area 2122 in the storage device 2120 for the body data (B3) of the newly added document container and allocates the storage area 2101 for the portal data (P3) of the newly added document container. The storage area 2101 originally contained the old portal data (P1).

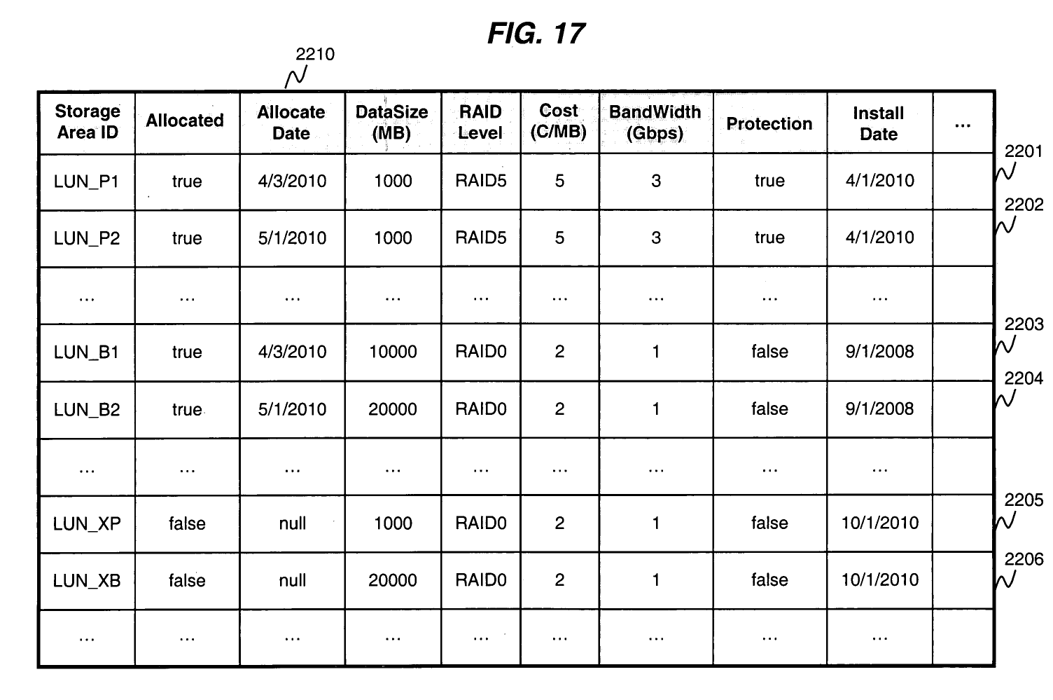

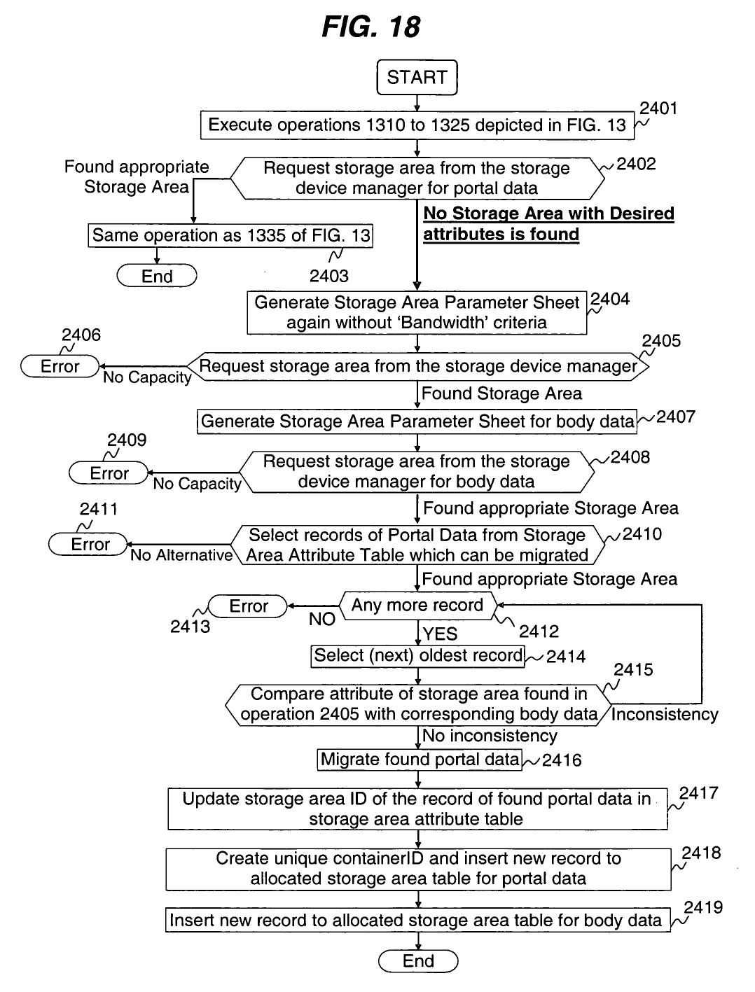

In this exemplary embodiment, to facilitate the migration of the oldest data, the storage area attribute table may contain an extra column 2210, as depicted in FIG. 17. FIG. 17 shows an exemplary data structure of the storage area attribute table according to the second embodiment of the present invention. Most of the data structure shown in FIG. 17 is analogous to the data structure depicted in FIG. 6, which was described above with reference to the first embodiment of the present invention. However, in FIG. 17, a column 2210 is added to facilitate the migration of old data. The value in column 2210 indicates the date when a particular storage area was allocated. For instance, rows 2201 and 2202 correspond to storage areas 2101 and 2102, while rows 2203 and 2204 correspond to storage areas 2111 and 2112. Information in rows 2205 and 2206 indicates that an unallocated storage area exists in the storage device 2120. This can be seen from the allocation date being set to “null” and the value of allocation flag being set to “false”.

Next, the process flow for creating a new document container according to the second exemplary embodiment of the present invention will be described with reference to FIG. 18. In the process depicted in FIG. 18, the old data is migrated to a different storage device to make room for the new data.

This process is launched upon user activating “Add Container” button 920 in the document container management user interface 900 depicted in FIG. 9. Next, a new container creation user interface 1200 (depicted in FIG. 12) is opened. The user inputs attributes of the new document container (using elements 1210-1270 in FIG. 12). Once the user specifies all of the desired/preferred attributes and directs the inventive system to proceed with container creation e.g., by clicking the “save” button (not depicted), the new container creation user interface 1200 is closed. The document manager 200 generates a storage area parameter sheet for only the portal data of the document and passes the generated parameter sheet to the storage device manager 210. These operations are analogous to the operations 1310 to 1325 described in FIG. 13 and are depicted as operation 2401 in FIG. 18.

In operation 2402, the document manager 200 sends a request for allocating storage area for the portal data to the storage device manager 210 using the generated storage area parameter sheet. If, in operation 2402, the storage device manager returns an appropriate storage area for the portal data, then the process proceeds to operation 2403. In operation 2403, the unique container ID is created and storage area is allocated, as depicted in FIG. 13, operation 1335.

If, on the other hand, in operation 2402, the storage device manager 210 returns an error indicating that no there is no available storage area, which meets the specified criteria or attributes, then the document manager 200 begins migrating old data, provided the migration is possible.

That is, the document manager 200 will generate a new storage area parameter sheet but, this time, without the “Bandwidth” constraint or attribute, as depicted in operation 2404 of FIG. 18. Next, in operation 2405, the document manager 200 again sends a request for allocating storage area for the portal data to the storage device manager 210 with this new storage area parameter sheet. If an error code is returned again, then storage capacity for the required size of the portal data is not available in the system and the process ends, in operation 2406.

If the storage area meeting the new criteria specified in the newly generated parameter sheet is found, then the found storage area is returned. That is, when the storage device manager 210 returns a storage area for this second parameter sheet, it means that sufficient storage area for the portal data exists but that the access speed of this storage area is not sufficient. In this event, as explained in greater detail below, the document manager 200 will migrate some of the old portal data to this storage area and use the storage area of the old portal data for the new portal data.

However, before migrating the old portal data, the document manager 200 tries to locate a storage area for storing the body data of the new document container. That is, as depicted in FIG. 18, in operation 2407, the document manager 200 generates a storage area parameter sheet for the body data of the new document container. In operation 2408, the document manager 200 sends a request for allocating storage area for the body data to the storage device manager 210 using the generated storage area parameter sheet. If, in operation 2408, the storage device manager 210 returns an error, then the system lacks the capacity to store the body data of the new document container, and the process ends with an error, in operation 2409.

If, on the other hand, in operation 2408, the storage device manger 210 returns allocated storage area, that indicates that the storage area for storing the body data of the new container is available. Accordingly, the document manager 200 starts migrating the old portal data.

That is, in operation 2410, the document manager 200 accesses the allocated storage area table 202 and selects records which meet all of the following criteria: a) the storage area is used for portal data; b) the size is the same as the size specified for the portal data of the new document container, and c) the speed is equal to or more than the specified speed (specified bandwidth) for the portal data of the new container. If no records are found in operation 2410, then the process ends and an error is returned, in operation 2411.

Next, if at least some records have been located in operation 2410 of FIG. 18, indicating that candidates for migration exist, the process loops in operations 2412 to 2415 until every found record is processed. In operation 2413, if every record has been processed but no migration could be executed, the process ends with an error.

On the other hand, in operation 2414, the oldest record (or next oldest data after the second loop) is identified by referring to the allocation date stored in column 2210 of table shown in FIG. 17. It is noted that one of ordinary skill in the art will readily recognize that record(s) for migration may be selected using other and/or additional criteria. For instance, the document manager 200 may also check the migration level specified by the user e.g., the user may specify a migration level of 0 for the data that should not be migrated at all and the migration level 5 for the data the migration of which should be a priority, when such migration becomes necessary. This migration level may be used instead or in addition to the allocation date criteria. Also, it is possible to select the data for migration based on the date of the last edit or access operation. One of ordinary skilled in the art would readily understand that many other variations are possible.

Next, in operation 2415, the document manager 200 turns to the allocated storage area table to find StorageArea ID of the body data's storage area that corresponds to the portal data selected in operation 2414. Then, the record of this corresponding body data (from the storage area attribute table) is selected, and the document manager looks up the BandWidth of the body data's storage area.

Subsequently, in operation 2415 of FIG. 18, the bandwidth (access speed) of the body data's storage area is compared with the corresponding characteristics of the storage area found in operation 2405 (the storage area to which the old portal data will be migrated to). If the bandwidth of the storage area found in operation 2405 is slower than the bandwidth of the body data's storage area, then an inconsistency is found and the document manager returns to operation 2412 to check the next record. That is, the portal data, even the oldest portal data, should be accessed faster than the corresponding body data. It should be noted that the above-described migration should not destroy this relationship between the portal data and the body data.

If it is determined that the migration will not destroy this relationship between the portal and body data, then in operation 2416, the old portal data is migrated. In this operation 2416, the document manager 200 migrates the content of storage area of the old portal data to the storage area found in operation 2405.

Next, in operation 2417, the document manager updates the Storage Area ID of the record of the old data in the allocated storage area table with the newly allocated storage area discovered in operation 2405. In operation 2418, the document manager 200 generates a new unique container ID, and adds a new record in the allocated storage area table for the new container. The new record includes the newly generated container ID, user specified container name, data type (portal) and storage area ID of the old data. In addition, in operation 2419, the document manager 200 adds a new record in the allocated storage area table for the body data. The new record includes the created unique container ID, user specified container name, DataType value corresponding to body data and storage area ID of the storage area found in operation 2408.

Next, a third exemplary embodiment of the present invention will be described. In the third embodiment of the present invention, document data from a storage area may be migrated to another storage area when faster or more reasonable storage devices than the storage device currently used is discovered in the environment.

Many of the structures, user interfaces, and processes of this embodiment are analogous to the structures, user interfaces, and processes described in relation to the first exemplary embodiment of the inventive concept. Accordingly, only differences between the structures, user interfaces, and processes of the third embodiment and the first embodiment are described below.

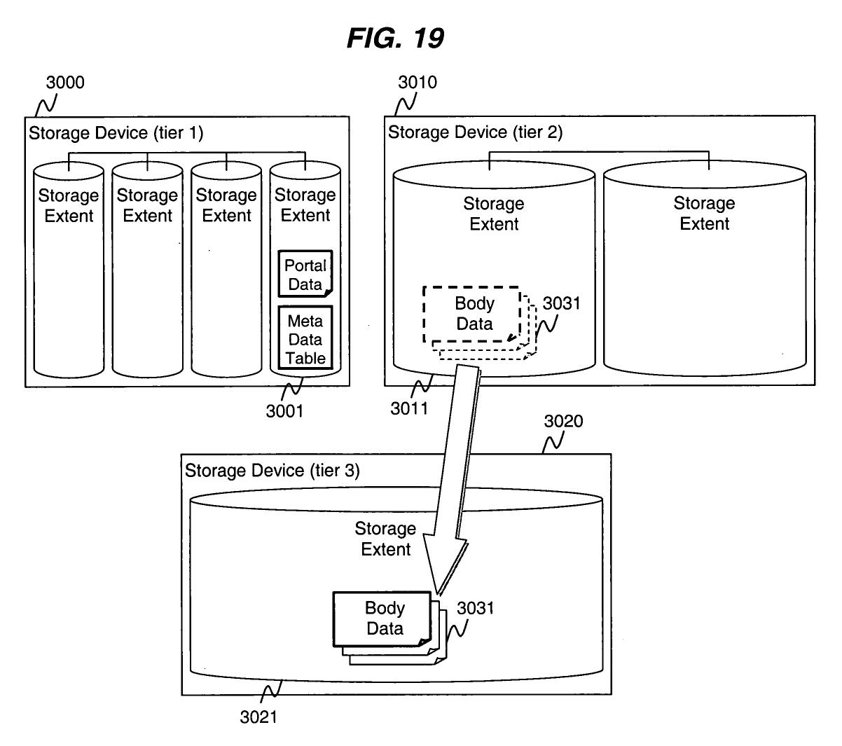

FIG. 19 illustrates a logical structure of the document container migration process according to this third embodiment of the present invention. In FIG. 19, the storage device 3000 of tier one has a number of storage areas including storage area 3001. The storage area 3001 stores the portal data and the metadata table of a container. Similarly, the storage device 3010 of tier two has a number of storage areas including storage area 3011. In the storage area 3011, body data 3031 is stored. By way of an example, a storage device 3020 (tier three), which is cheaper than the storage device 3010 (tier two) becomes available. That is, the storage system according to this exemplary embodiment of the present invention discovers the storage device 3020 in its environment. The newly discovered storage device 3020 also has a number of storage areas including the storage area 3021. As depicted in FIG. 19, the body data 3031 is migrated from the storage area 3011 of tier two storage device 3010 to the storage area 3021 of tier three storage device 3020. Since the tier three storage device 3020 is a cheaper device, the cost of storing the data is decreased.

The migration of the document containers to faster or cheaper storage devices may be initiated by the user. By way of an example, the user interface for the container management depicted in FIG. 9 may include a refresh button. When the user actives the refresh button, the document manager 200 may start the process of migration by a) finding storage devices within its environment, b) evaluating the characteristics of the newly found storage devices, and c) migrating document container if the newly found devices have some superior attributes to the other storage devices being utilized.

Moreover, by way of an example, the user may not like the migration for one reason or another. Accordingly, the user may undo the migration by depressing a special button such as “back” button on the container management user interface depicted in FIG. 9. The user may then undo all of the previously executed migration operations. That is, the migration can be undone by referencing a migration log. The migration log enables the inventive system to track all data movements within the environment. Each record has a time stamp indicating when (date and time) data was stored to a particular storage area of a particular storage device, an old location ID indicating where the data was previously stored (the previous storage area and the storage device), and a new location ID indicating where the data is now stored (the current storage area and the current storage device). Accordingly, when the user depresses a “back” button, for example, the document manager 200 accesses the migration log and reverts the data back to their original storage areas. The migration log is then updated accordingly.

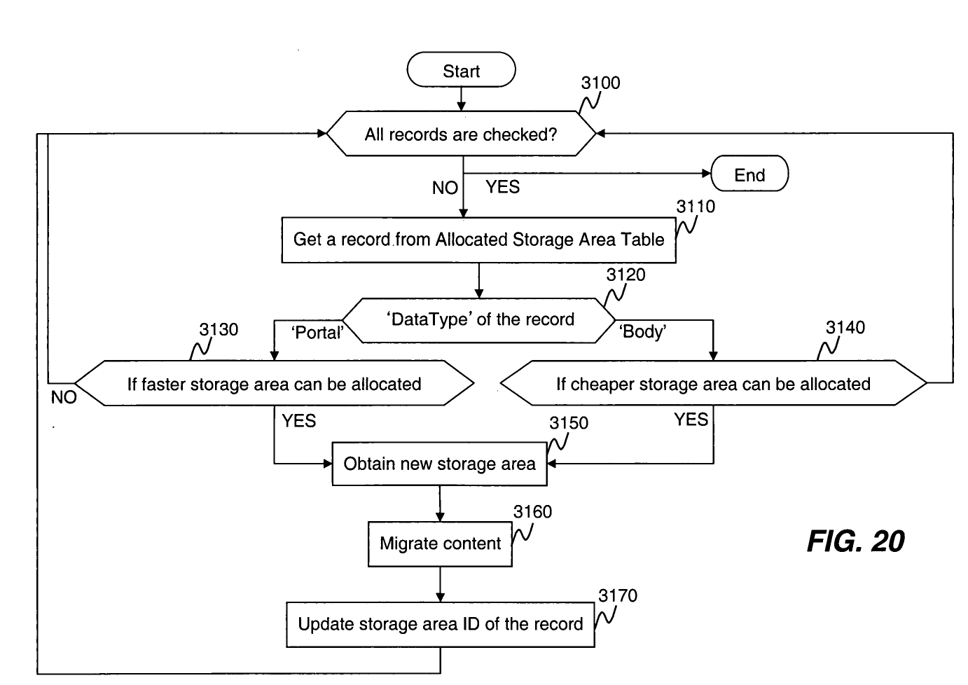

The document migration process flow according to the third exemplary embodiment of the present invention is depicted in FIG. 20. The process begins with the user activating a refresh button as described above. The process loops from operations 3100 to 3170 until every record of the storage area stored in the allocated storage area table is checked. In operation 3110, the next record is obtained from the allocated storage area table. Next, in operation 3120, the document manager checks if the DataType of the record is “portal”. If the DataType is portal, the process proceeds to operation 3130; otherwise, (when the DataType is “body”) the process proceeds to operation 3140.

In operation 3130, depicted in FIG. 20, the document manager 200 contacts the storage device manager 210 to check if there is a storage area of an equivalent or larger size on a storage device with a faster access speed (bandwidth) than the storage area currently used to store portal data. If such storage area exists, the process proceeds to operation 3150; otherwise, the process proceeds to operation 3100.

If, on the other hand, in operation 3120, the DataType of the record is “body”, in operation 3140, the document manager 200 contacts the storage device manger 210 to check if there is a storage area that is of equivalent or larger size but is cheaper than the storage area currently used for the body data. If such storage area exists, the process proceeds to operation 3150; otherwise, the process proceeds to operation 3100.

In operation 3150, the document manager 200 obtains a new (faster or cheaper) storage area. Next, in operation 3160, the data of the record currently being checked is migrated from its current storage area to the newly obtained storage area. In operation 3170 of FIG. 20, the storage area ID of the record currently being checked is updated with the storage area ID of the new storage area, which is obtained in operation 3150.

The above and other features of the invention including various novel method steps and a system of the various parts and components have been particularly described with reference to the accompanying drawings and pointed out in the claims. It will be understood that the particular process and construction of parts embodying the present invention is shown by way of illustration only and not as a limitation of the invention. The principles and features of this invention may be employed singly or in any combination in varied and numerous embodiments without departing from the spirit and scope of the invention as defined by the appended claims.

What is claimed is:

1. A data management system comprising:
a first storage device storing first user-viewable data;
at least one second storage device, physically separate from the first storage device, storing at least one second data, wherein the at least one second data is associated with the first data;
a metadata storage area storing metadata associated with the first data and the at least one second data;
a storage device management processor operable to cause allocation of storage areas of the first and the at least one second storage devices; and
a data management processor operable to cause the first data to be stored in the first storage device and the at least one second data to be stored in the at least one second storage device and to cause a record to be added into the metadata storage area, the record indicating a relationship between the stored first data and the at least one stored second data,
wherein the storage device management processor is operable to cause allocation of a-storage area for the first data and a storage area for the at least one second data based on a request from the data management processor.

2. The data management system according to claim 1, wherein the first data comprises information about contents of the at least one second data.

3. The data management system according to claim 1, wherein the at least one second data comprises the first data.

4. The data management system according to claim 1, wherein the at least one second data comprises at least one of a group consisting of text, image, audio, and video data.

5. The data management system according to claim 1, wherein the first data comprises an abstract or a summary of the at least one second data.

6. The data management system according to claim 1, wherein a performance characteristic of the first storage device is different from a corresponding performance characteristic of the at least one second storage device.

7. The data management system according to claim 1, wherein the access speed of the first storage device exceeds the access speed of the at least one second storage device.

8. The data management system according to claim 1, wherein the at least one second storage device provides lower data storage cost than the first storage device.

9. The data management system according to claim 1, wherein the first storage device and the at least one second storage device, each comprises at least one disk drive and a controller.

10. The data management system according to claim 9, wherein the at least one disk drive is a RAID drive.

11. The data management system according to claim 1, wherein the first storage device comprises fiber channel interface and wherein the at least one second storage device comprises Advanced Technology Attachment (ATA) interface.

12. The data management system according to claim 1, wherein the first data is stored in the first storage device in the first storage area and the second data is stored in the at least one second storage device in the second storage area and wherein the first storage area, the second storage area and the metadata storage area form a single logical storage container.

13. The data management system according to claim 12, wherein the metadata portion of the container comprises a name of the container, a hierarchy information, a type of the first data and a type of the at least one second data.

14. The data management system according to claim 1, wherein the first storage device and the at least one second storage device comprise a plurality of hierarchical folders and wherein the folders of the first storage device correspond to the folders of the at least one second storage device.

15. The data management system according to claim 14, operable to receive from a user information specifying the plurality of hierarchical folders and to automatically generate the specified plurality of hierarchical folders in the first storage device and the at least one second storage device.

16. The data management system according to claim 12, further comprising a storage allocation table comprising a name of the container and storage locations for the first data and the at least one second data associated with the container, wherein the storage allocation table is managed by the data management processor.

17. The data management system according to claim 1, wherein the storage management device processor stores a storage area attribute table comprising at least one attribute of the first storage device and the at least one second storage device.

18. The data management system according to claim 17, wherein the at least one attribute comprises at least one of a group consisting of: a data size, a RAID level, a cost of storage, a bandwidth, and information on whether a particular portion of the first storage device or the at least one second storage device is allocated to a host computer.

19. The data management system according to claim 1, further comprising an application table comprising information on an application program for handling each of the first data and the at least one second data, wherein the application table is managed by the data management processor.

20. The data management system according to claim 1, wherein the document management processor submits a storage allocation request for storage allocation in the first storage device and the at least one second storage device and wherein the storage allocation request comprises a storage extent parameter sheet.

21. The data management system according to claim 20, wherein the storage extent parameter sheet comprises a temporary table passed to the storage device management processor that manages the first storage device and the at least one second storage device, and wherein the storage extent parameter sheet comprises necessary and preferred attributes of the first storage device and the at least one second storage device.

22. The data management system according to claim 1, wherein the document management processor is operable to cause the first data to be migrated from the first storage device to a third storage device and new first data to be stored in the first storage device, when a predetermined condition is satisfied.

23. The data management system according to claim 22, wherein the document management processor causes the first data to be reverted back into the first storage device based on user instruction.

24. The data management system according to claim 22, wherein the data management processor is operable to store a storage allocation table comprising, for each of the first data and the at least one second data, at least one user-defined migration parameter, and wherein, upon satisfaction of a predefined condition, the data management processor is operable to determine whether to migrate the old first data based on the at least one user-defined migration parameter specified for the old first data.

25. The data management system according to claim 1, wherein, the data management processor is operable to detect an addition of new storage device and compare attributes of the new device with attributes of the first storage device and the at least one second storage device, wherein, if the data management processor determines that the new storage device is a more efficient device, based on the compared attributes, than the first storage device, the data management processor causes the first data to be moved to the new storage device, and
wherein, if the data management processor determines, based on the compared attributes, that the new storage device is a less efficient device than the first storage device and a more efficient device than the at least one second storage device, the data management processor causes a portion of the at least one second data to be moved to the new storage device.

26. The data management system according to claim 25, wherein, if the data management processor determines that the new storage device is the more efficient device, based on the compared attributes, than the first storage device storing the first data, the data management processor causes the first data to be moved to the new storage device, and
wherein, if the first storage device is full with the first data, the data management processor causes the new first data to be stored in the new storage device, and old first data to be migrated from the first storage device to the new storage device.

27. The data management system according to claim 1, wherein, the data management processor is operable to detect a new storage device, and if the data management processor determines that the new storage device is a higher access speed device than the first storage device storing the first data, the data management processor causes the first data to be moved to the new storage device, and if the data management processor determines that the new storage device is a slower access speed device than the first storage device and a higher access speed device than the at least one second'storage device, the data management processor causes a portion of the second data to be moved to the new storage device.

28. The data management system according to claim 1, wherein, the data management processor is operable to detect a new storage device, and if the data management processor determines that the new storage device is larger in size than the first storage device, the data management processor causes the first data to be moved to the new storage device, and if the data management processor determines that the new storage device is smaller in size than the first storage device and larger-in size than the second storage device, the data management processor causes the second data to be moved to the new storage device.

29. The data management system according to claim 1, wherein the first data comprises clinical records and the second data comprises at least one of a group consisting of a related document, an x-ray image, and a test result.

30. The data management system according to claim 1, wherein the first data comprises a thumbnail and the second data comprises a corresponding photo image.

31. The data management system according to claim 1, wherein the first data comprises a body of an email and the second data comprises an attachment to the email.

32. The data management system according to claim 1, wherein the first data comprises an advertisement data and the second data comprises at least one full stream of movie or wherein the first data comprises information accessible to all viewers and the second data comprises information accessible to subscriber members only.

33. The data management system according to claim 1, wherein the first and second data comprises at least one of a group consisting of a technical document and a document archive.

34. The data management system according to claim 33, wherein the first data comprises a summary of a second data.

35. The data management system according to claim 1, wherein the data management processor is operable to detect an addition of new storage device and is operable to compare attributes of the new device with attributes of the first storage device and the at least one second storage device.

36. The data management system according to claim 35, wherein, when the data management processor determines that the new storage device is a more cost effective device, based on the compared attributes, than the second storage device, the data management processor causes the second data to be moved to the new storage device.

37. The data management system according to claim 35, wherein, the data management processor is operable to detect a new storage device, and if the data management processor determines that the new storage device is larger in size than the second storage device, the data management processor causes the second data to be moved to the new storage device.

38. The data management system according to claim 1, wherein, when the first data is viewed by the user, the corresponding body data is pre-fetched by the data management processor.

39. The data management system according to claim 1, wherein the data management processor is operable to detect an addition of new storage device and compare attributes of the new device with attributes of the first storage device and the at least one second storage device,
wherein, the data management processor causes migration of one of the first and second data to the new storage device and wherein, the at least one of the first and second data is not migrated if it is designated as not available for migration.

40. The data management system according to claim 1, wherein the data management processor is operable to detect an addition of new storage device and compare attributes of the new device with attributes of the first storage device and the at least one second storage device and wherein, based on the compared attributes, the data management processor causes migration of one of the first and second data to the new storage device and wherein, which of the at least one of the first and second data is migrated is determined based on designation of migration priority of each of the at lest one of the first and second data.

41. A data management method comprising:
receiving first user-viewable data and second data;
automatically separating the first data and the second data;
allocating a storage area of a first storage device and a storage area of at least one second storage device;
storing the first data in the allocated storage area of the first data storage device;
storing the second data in the allocated storage area of the at least one second storage device, physically separate from the first storage device, wherein the at least one second data is associated with the first data; and
adding a record into the metadata storage area, the record indicating a relationship between the stored first data and the at least one stored second data, wherein the metadata is associated with the first data and the at least one second data.

42. A computer-readable medium embodying one or more sequences of instructions, which when executed by one or more processors, causes the one or more processors to perform a method comprising:
receiving first user-viewable data and second data;
automatically separating the first data and the second data;
allocating a storage area of a first data storage device and allocating a storage area of at least one second storage device;
storing the first data in the allocated storage area of the first data storage device;
storing the second data in the allocated storage area of the at least one second storage device, physically separate from the first storage device, wherein the at least one second data is associated with the first data;
adding a record into the metadata storage area, the record indicating a relationship between the stored first data and the at least one stored second data, wherein the metadata is associated with the first data and the at least one second data.
